(19) United States
(12) Patent Application Publication
(10) Pub. No.: US 2025/0326868 A1
(43) Pub. Date: Oct. 23, 2025

(54) METHOD AND DEVICE FOR PREPARING ETHYLENE-POLAR MONOMER COPOLYMER

(71) Applicant: ZHEJIANG UNIVERSITY, Hangzhou (CN)

(72) Inventors: Yao YANG, Hangzhou (CN); Xiaoqiang FAN, Hangzhou (CN); Jingdai WANG, Hangzhou (CN); Congjing REN, Hangzhou (CN); Yongrong YANG, Hangzhou (CN)

(73) Assignee: ZHEJIANG UNIVERSITY, Hangzhou (CN)

(21) Appl. No.: 19/053,776

(22) Filed: Feb. 14, 2025

(30) Foreign Application Priority Data
Feb. 20, 2024 (CN) 202410189414.7

(51) Int. Cl. C08F 2/01; C08F 210/02; C08K 5/14

(52) U.S. Cl. CPC C08F 2/01; C08F 210/02; C08K 5/14; C08F 2400/02; C08F 2400/04

(57) ABSTRACT

A method for preparing an ethylene-polar monomer copolymer is disclosed. The method contains: providing at least one tank reactor and a tubular reaction system containing at least one tubular reactor; contacting ethylene, a polar monomer, and an organic peroxide and carrying out a polymerization reaction in the tank reactor and the tubular reactor under conditions including a pressure of 100-400 MPa and a temperature of 120-350° C. to prepare the ethylene-polar monomer copolymer. Also disclosed is a device for preparing an ethylene-polar monomer copolymer.

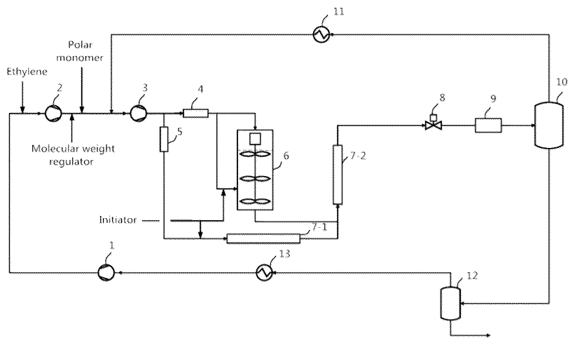

This application claims the benefit of Chinese patent application 202410189414.7 filed Feb. 20, 2024, the content of which is incorporated herein by reference.

### FIELD

The present disclosure relates to the technical field of high pressure process free radical polymerization method and devices, in particular to a method and device for preparing an ethylene-polar monomer copolymer.

### BACKGROUND

The ethylene-polar monomer copolymer has excellent compatibility and flexibility, high melting point, high thermal stability, and desired heat-scalability. In particular, the ethylene-polar monomer copolymer has the advantages such as high polarity and thermal stability, making it is widely used in the fields of construction, automobile, house decoration, sporting equipment and the like.

The commercial ethylene-polar monomer copolymers are typically produced by free-radical polymerization of ethylene and polar monomers under conditions of high-temperature and high-pressure, the operating pressure reaches a high level of 100-400 MPa, and the operating temperature is between 100-350° C. Tank reactors and tubular reactors are currently the commonly used reactors for producing ethylene-polar monomer copolymer. Because the existing processes typically use a single tank reactor or a single tubular reactor, there is limited means for regulating and controlling the product molecular chain structure. In addition, given that the high pressure free radical polymerization process is characterized by high reaction rate and large amount of heat release, the localized hot spots are more likely to form in the tank reactors than the tubular reactors, thereby causing the decomposition accidents. The tubular reactors have the advantage of high monomer conversion rate and low energy consumption, however, due to low back-mixing degree of materials in the tubular reactor, for the comonomer with a high reactivity ratio, the molecular chain produced by the tubular reactor through copolymerization of ethylene-polar monomer has uneven distribution of comonomer. It should be further indicated that due to the limitation of heat removal method of the tank reactor and the restraint of pressure drop of the tubular reactor, regardless of the scheme of using a single tubular reactor or a single tank reactor, or the scheme of simply connecting a tubular reactor and a tank reactor in series, both cannot efficiently improve the monomer conversion rate (especially the ethylene monomer conversion rate) under the premise of ensuring the steady operation of the reactors.

### SUMMARY

In regard to the defects in the prior art, the present disclosure provides a method and device for preparing an ethylene-polar monomer copolymer. The method of the present disclosure has a higher conversion rate of monomer than the existing high pressure method kettle process and tubular process, to solve the problems that the product molecular chain structure in the high pressure polymerization reactor can hardly be regulated and controlled (the regulation scope is limited), the monomer conversion rate is low, and the production cost is high.

The first aspect of the present disclosure provides a method for preparing an ethylene-polar monomer copolymer comprising:
providing at least one tank reactor and a tubular reaction system comprising at least one tubular reactor;
contacting ethylene, a polar monomer, and an organic peroxide and carrying out a polymerization reaction in the tank reactor and the tubular reactor under conditions including a pressure of 100-400 MPa and a temperature of 120-350° C. to prepare the ethylene-polar monomer copolymer, wherein materials exiting the tank reactor are either cooled or not cooled and introduced into a central feed opening of the one or more tubular reactors, or a position at 10%-80% of the total tube length of a plurality of tubular reactors connected in series, the central feed opening of the tubular reactor is located at 10%-80% of the tube length of the tubular reactor.

In an optional embodiment of the present disclosure, the tubular reaction system comprises one tubular reactor; the materials exiting the tank reactor are either cooled or not cooled and introduced into the central feed opening of the tubular reactor. In an optional embodiment of the present disclosure, the tubular reaction system comprises a plurality of tubular reactors, which may be connected in series, connected in parallel or a combination of connected in series and parallel. The materials exiting the tank reactor are either cooled or not cooled and introduced into the central feed opening of the one or more tubular reactors.

In an optional embodiment of the present disclosure, the tubular reaction system at least comprises a plurality of tubular reactors connected in series, the materials exiting the tank reactor are either cooled or not cooled and introduced into a position at 10%-80% of the total tube length of a plurality of tubular reactors connected in series. It should be noted that the position at 10%-80% of the total tube length may be located on the tube wall of a tubular reactor, or may be located at an interconnecting piece between two tubular reactors connected in series, the interconnecting piece may be a pipeline, a three-way piping or a four-way piping.

It should be noted that the materials exiting the tank reactor may be further divided into a plurality of feedstocks and introduced into a tubular reaction system, wherein each feedstock meets the aforementioned feed location requirements in the tubular reaction system. Accordingly, there may be a plurality of feed locations on the tubular reaction system for receiving the material exiting the tank reactor.

The central feed opening in the present disclosure is distinct from the main feed inlet of the tubular reactor, the main feed inlet of the tubular reactor in the field generally refers to the feed port located at the upstream terminal of the tubular reactor, while the central feed opening is located at the tube wall of the tubular reactor. In the present disclosure, the central feed opening may be located at 10%-80% of the tube length of the tubular reactor, optionally located at 25%-60% of the tube length of the tubular reactor.

In an exemplary embodiment of the present disclosure, the polar monomer is vinyl acetate, an acrylic ester monomer having 4-12 carbon atoms, or a methacrylate monomer having 4-12 carbon atoms. Optionally, the polar monomer is vinyl acetate, methyl acrylate, ethyl acrylate, butyl acrylate, methyl methacrylate, ethyl methacrylate and the like.

In an exemplary embodiment of the present disclosure, the tank reactor has an operating pressure of 100-400 MPa, preferably 120-350 MPa, more preferably 150-270 MPa; an operating temperature of 120-350° C., preferably 135-280° C., more preferably 145-250° C. The operating pressure of the tank reactor refers to an average pressure of the materials in the tank reactor. The operating pressure of the tank reactor may be measured with a pressure gauge mounted on the tank reactor, a pressure gauge mounted on the organic peroxide feeding pump upstream of the tank reactor, and a pressure gauge mounted on the feeding pipeline of the tank reactor. If there is a plurality of pressure gauges, the representative measured values of the pressure gauges are selected, and the arithmetic mean of the measurement values is calculated as the operating pressure of the tank reactor. The operating temperature of the tank reactor is an average temperature of the materials in the tank reactor and can be measured with temperature gauge mounted on the tank reactor. If there is a plurality of temperature gauges, the representative measured values of the temperature gauge are selected, and the arithmetic mean of the measurement values is calculated as the operating temperature of the tank reactor.

In an exemplary embodiment of the present disclosure, the tubular reactor has an operating pressure of 100-400 MPa, preferably 120-350 MPa, more preferably 150-270 MPa; an operating temperature of 120-350° C., preferably 135-280° C., more preferably 145-250° C. The operating pressure of the tubular reactor refers to an average pressure of the materials in the tubular reactor. The operating pressure of the tubular reactor may be measured with a pressure gauge mounted on the tubular reactor, a pressure gauge mounted on the organic peroxide feeding pump upstream of the tubular reactor, and a pressure gauge mounted on the feeding pipeline of the tubular reactor. If there is a plurality of pressure gauges, the representative measured values of the pressure gauges are selected, and the arithmetic mean of the measurement values is calculated as the operating pressure of the tubular reactor. The operating temperature of the tubular reactor is an average temperature of the materials in the tubular reactor and can be measured with temperature gauge mounted on the tubular reactor. If there is a plurality of temperature gauges, the representative measured values of the temperature gauge are selected, and the arithmetic mean of the measurement values is calculated as the operating temperature of the tubular reactor.

In an exemplary embodiment of the present disclosure, the tubular reaction system comprising one tubular reactor is adopted, an absolute value of a difference between an inlet pressure of the tank reactor and an inlet pressure of the tubular reaction system is less than or equal to 40 MPa, optionally, the absolute value of the difference between an inlet pressure of the tank reactor and an inlet pressure of the tubular reaction system is less than or equal to 20 MPa. When the tubular reaction system comprising a plurality of tubular reactors is adopted, an absolute value of a difference between an inlet pressure of the tank reactor and an inlet pressure of the tubular reaction system is less than or equal to 40 MPa, optionally, the absolute value of the difference between an inlet pressure of the tank reactor and an inlet pressure of the tubular reaction system is less than or equal to 20 MPa. By controlling the difference between an operating pressure of the tank reactor and an operating pressure of the tubular reactor, the flow in the tank reactor and the tubular reactor can be controlled smoothly, thereby reducing the potential risks for safe and smooth operation of the polymerization device due to the factors such as material flow fluctuation and temperature fluctuation.

In an exemplary embodiment of the present disclosure, a tubular reaction system comprising one tubular reactor is adopted, a difference between an outlet pressure of the tank reactor and an outlet pressure of the tubular reaction system is more than or equal to 5 MPa, optionally, the difference between an outlet pressure of the tank reactor and an outlet pressure of the tubular reaction system is more than or equal to 10 MPa. When a tubular reaction system comprising a plurality of tubular reactors is adopted, a difference between an outlet pressure of the tank reactor and an outlet pressure of the tubular reaction system is more than or equal to 5 MPa, optionally, the difference between an outlet pressure of the tank reactor and an outlet pressure of the tubular reaction system is more than or equal to 10 MPa. By controlling that an outlet pressure of the tank reactor is at least 5 MPa above an outlet pressure of the tubular reactor, the materials exiting the tank reactor and the materials in the tubular reactor (especially polymers) can be uniformly blended, thereby ensuring stability of product quality. In addition, the mixing of the tank reactor materials and tubular reactor materials can further initiate the reactions, which allows a wider range of adjustable molecular structures (e.g., short branch chain content, monomer sequence distribution) of the product.

In an exemplary embodiment of the present disclosure, an average flow rate of the materials in the tubular reactor is within a range of 10-25 m/s, preferably within the range of 12-20 m/s, more preferably within the range of 13-18 m/s. The average flow rate of the materials in the tubular reactor refers to the arithmetic mean value of the flow rate of the materials at an inlet of the tubular reactor and the flow rate of the materials at an outlet of the tubular reactor. The flow rate of the materials in the tubular reactor can be counted based on the density and flow rate calculated according to the PC-SAFT equation, or may be measured by a non-invasive flow measurement device (e.g., an ultrasonic flow meter).

In an exemplary embodiment of the present disclosure, a mass

concentration (i.e. mass fraction) of the ethylene-polar monomer copolymer in the materials at the tubular reaction system outlet is higher than a mass concentration (i.e. mass fraction) of the ethylene-polar monomer copolymer at the tank reactor outlet, optionally, the mass concentration of the ethylene-polar monomer copolymer in the materials at the tubular reaction system outlet is more than 1.2 times the concentration of the ethylene-polar monomer copolymer at the tank reactor outlet.

In an exemplary embodiment of the present disclosure, a mass fraction of polar monomer in the ethylene-polar monomer copolymer is within a range of 3-45 wt %, preferably within the range of 10-35 wt %. The mass fraction of polar monomer in the ethylene-polar monomer copolymer may be calculated by means of Fourier Transform Infrared Spectroscopy, ATR (Attenuated Total Reflectance)-Infrared, nuclear magnetic resonance spectroscopy, elemental analysis and other methods.

In an exemplary embodiment of the present disclosure, the method may add a molecular weight regulator or may not add a molecular weight regulator. The aforementioned operation may controls the molecular weight of the ethylene-polar monomer copolymer. During the production process of certain ethylene-polar monomer copolymer products, one or more of hydrogen gas, C₁-C₆ alkanes, C₁-C₆ alkenes, aldehydes, ketones or alcohols, preferably one or more of propylene, butene, hexene, propyl aldehyde, butyl aldehyde, acetone, more preferably propene and propionaldehyde, may be optionally added.

In an exemplary embodiment of the present disclosure, a device for preparing an ethylene-polar monomer copolymer comprising:
a) a tubular reaction system comprising at least one tubular reactor, and at least one tank reactor;
b) at least one heat exchanger connected with an inlet of the tank reactor;
c) at least one heat exchanger connected with an inlet of the tubular reactor;
d) at least one pressure reducing valve located upstream or downstream of the tank reactor;
f) at least one pressure reducing valve connected to an outlet of the tubular reactor;
wherein materials exiting the tank reactor are either cooled or not cooled and introduced into a central feed opening of the one or more tubular reactors, or a position at 10%-80% of the total tube length of a plurality of tubular reactors connected in series, the central feed opening of the tubular reactor is located at 10%-80% of the tube length of the tubular reactor.

In an exemplary embodiment, at least one pressure reducing valve located upstream of the tank reactor controls the operating pressure of the tank reactor, and at least one pressure reducing valve located upstream of the tubular reactor controls the flow rate of the materials in the tubular reactor.

In an exemplary embodiment, the tank reactor and a portion of the tubular reactor are connected in parallel, the materials then enter the remainder of the tubular reactor, i.e., the materials exiting the tank reactor are introduced into the central feed opening of the tubular reactor. The central feed opening of the tubular reactor is located at 10%-80% of the tube length of the tubular reactor, preferably located at 25%-60% of the tube length of the tubular reactor.

Compared with the prior art, the present disclosure produces the favorable effects as follows:
(1) compared with the prior art, the present disclosure can provide a method with a significantly reduced pressure drop of device, an increased conversion rate of ethylene and polar monomers, and reduced energy consumption, by using a combination of tubular reactors and tank reactors, selecting the feed location at which the materials exiting the tank reactor is introduced into the tubular reaction system, and selecting the operating temperatures and pressures of the tubular reactors and the tank reactors.
(2) due to a combination of a tubular reactor and a tank reactor, the molecular chain structure of the product can be improved, and an ethylene-polar monomer copolymer with a particular brand name can be produced.

### BRIEF DESCRIPTION OF THE DRAWINGS

The FIGURE illustrates a schematic flow diagram for preparing an ethylene-polar monomer copolymer.

In the FIGURE, the reference signs are as follows: 1. First compressor; 2. Second compressor; 3. Third compressor; 4/5. Heat exchanger; 6. Tank reactor; 7-1. First part of tubular reactor; 7-2. Second part of tubular reactor; 8. Pressure reducing valve; 9. Product cooler; 10. High-pressure separator; 11. High-pressure circulation heat exchange system; 12. Low-pressure separator; 13. Low-pressure circulation heat exchange system.

### DETAILED DESCRIPTION

The present disclosure is further described and illustrated below with reference to the specific embodiments. The technical features of each embodiment of the present disclosure may be mutually combined under the premise of without mutual conflict.

The FIGURE illustrates a process for preparing an ethylene-polar monomer copolymer. As described in the FIGURE, fresh ethylene, polar monomer, and molecular weight regulator were pressurized and entered a tank reactor 6 and a first part of tubular reactor 7-1, then contacted with an initiator (organic peroxide) to initiate copolymerization of the ethylene-polar monomers for preparing an ethylene-polar monomer copolymer.

In an exemplary embodiment of the present disclosure, a first compressor 1 pressurized the materials from a low-pressure circulation heat exchange system 13, the pressurized materials were mixed with a fresh ethylene material; the mixture was subsequently introduced into an inlet of a second compressor 2. After a second compressor 2 pressurized the materials from the first compressor 1, a molecular weight regulator and a polar monomer were introduced; the materials were delivered to an inlet of a third compressor 3. The outlet pressure of the first compressor 1 was within the range of 1-5 MPa, the outlet pressure of the second compressor 2 was within the range of 10-40 MPa, and the outlet pressure of the third compressor 3 was within the range of 100-400 MPa.

In an exemplary embodiment of the present disclosure, as shown in the FIGURE, the materials exiting the third compressor 3 passed through a heat exchanger 4 and a heat exchanger 5 and entered a tank reactor 6 and a first part of tubular reactor 7-1, respectively; the materials exiting the tank reactor 6 were mixed with the materials exiting the first part of tubular reactor 7-1 and entered a second part of tubular reactor 7-2. The materials exiting the second part of tubular reactor 7-2 passed through the pressure reducing valve 8 and subsequently entered a product cooler 9 for cooling, the cooled materials were separated sequentially by passing through a high-pressure separator 10 and a low-pressure separator 12 to obtain a high pressure recycled material, a low pressure recycled material, and an ethylene-polar monomer copolymer. It should be noted that the two parts of the tubular reactor shown in the FIGURE were merely schematic, they can be two separate tubular reactors, or two reaction sections or two parts of a total tubular reactor. When they were two reaction parts of a tubular reactor, the materials exiting the tank reactor in the FIGURE were introduced into the tubular reactor from a central feed opening of the total tubular reactor, the central feed opening was located on the tube wall at 10%-80% of the tube length of the tubular reactor. When they were two separate tubular reactors, the introduction site of the materials exiting the tank reactor should be located at 10%-80% of the total tube length of the two tubular reactors.

In an exemplary embodiment of the present disclosure, the unreacted ethylene and polar monomer separated from the high-pressure separator 10 were cooled by a high-pressure circulation heat exchange system 11 and subsequently introduced into an inlet of the third compressor 3. Wherein the high-pressure circulation heat exchange system included at least two heat exchangers and at least one separator. The heat exchangers may be at least one of tube-in-tube heat exchanger, tubular heat exchanger, waste heat boiler, or a combination thereof.

In an exemplary embodiment of the present disclosure, the unreacted ethylene and polar monomer separated in the low-pressure separator 12 passed through a low-pressure circulation heat exchange system 13 and returned to an inlet of the first compressor 1. The low-pressure circulation heat exchange system 13 included at least one heat exchanger and one separator.

### Example 1

An ethylene-polar monomer copolymer was prepared in the high pressure free radical polymerization device shown in the FIGURE, the polar copolymer monomer was vinyl acetate. A portion of the materials was pressurized to 250 MPa by a third compressor 3, the pressured was reduced to 240 MPa by a pressure reducing valve and then cooled to 50° C. by a heat exchanger 4, subsequently entered a tank reactor 6 for performing the reaction, an operating temperature of the tank reactor 6 was 210° C. The remaining material pressurized to 250 MPa by the third compressor 3 was pre-heated to 145° C. by a heat exchanger, and then entered a first part of tubular reactor 7-1 for performing the reaction. Wherein a flow rate of material entered the tank reactor 6 was 45 tons per hour, and the flow rate of material entered the first part of tubular reactor 7-1 was 45 tons per hour. The mass fraction of ethylene-vinyl acetate copolymer in the materials exiting the tank reactor 6 was 15%. The materials exiting the tank reactor 6 entered a second part of tubular reactor 7-2 at a location (the central feed opening) with a distance of 540 m from an inlet of the tubular reactor, where the central feed opening of the tubular reactor was located at 36% of the total tube length of the tubular reactor. The mass fraction of ethylene-vinyl acetate copolymer in the materials exiting the tubular reactor was 24%. The tubular reactor had an inlet pressure of 245 MPa and an outlet pressure of 210 MPa. An average flow rate of the materials in the tubular reactor was 14.5 m/s, and the operating temperature was 220° C.

The absolute value of a difference between an inlet pressure of the tank reactor 6 and an inlet pressure of the tubular reactor was 5 MPa; a difference between an outlet pressure of the tank reactor 6 and an outlet pressure of the tubular reactor was 30 MPa.

The reaction was initiated in the tank reactor 6 by using an organic peroxide. The organic peroxide species were bis(2-ethylhexyl) peroxydicarbonate and tert-butyl peroxyvalerate with a mass ratio of 1:1.

The reaction was initiated in the tubular reactor by using an organic peroxide. The organic peroxide species were bis(2-ethylhexyl) peroxydicarbonate, tert-butyl peroxyvalerate, tert-butyl peroxy-2-ethylhexanoate, and tert-butyl peroxybenzoate with a mass ratio of 1:1:1:1. The organic peroxides entered the tubular reactor at 0 m, 540 m, 1,020 m of the total tube length of the tubular reactor, respectively.

The content of vinyl acetate in the ethylene-vinyl acetate copolymer was 27 wt %. The conversion rate of ethylene monomer was 24%. The pressure drop of the tubular reactor was 35 MPa.

The ethylene monomer conversion rate of Example 1 was increased by 9% than the Comparative Example 1, after the use of a tank reactor, the ethylene-vinyl acetate copolymer with a relatively high concentration was obtained with a reduced pressure drop loss. Therefore, the ethylene monomer conversion rate of Example 1 was increased by 41% than the Comparative Example 2, and the ethylene monomer conversion rate of Example 1 was increased by 20% than the Comparative Example 3.

### Example 2

An ethylene-polar monomer copolymer was prepared in the high pressure free radical polymerization device shown in the FIGURE, the polar copolymer monomer was vinyl acetate. A portion of the materials was pressurized to 230 MPa by a third compressor 3, the pressured was reduced to 220 MPa by a pressure reducing valve and then cooled to 50° C. by a heat exchanger 4, subsequently entered a tank reactor 6 for performing the reaction, an operating temperature of the tank reactor 6 was 220° C. The remaining material pressurized to 230 MPa by the third compressor 3 was pre-heated to 140° C. by a heat exchanger 5, and then entered a first part of tubular reactor 7-1 for performing the reaction. Wherein the flow rate of material entered the tank reactor 6 was 60 tons per hour, and the flow rate of material entered the first part of tubular reactor 7-1 was 60 tons per hour. The mass fraction of ethylene-vinyl acetate copolymer in the materials exiting the tank reactor 6 was 16%. The materials exiting the tank reactor 6 was cooled to 190° C., and then entered a second part of tubular reactor 7-2 at a location (the central feed opening) with a distance of 600 m from an inlet of the tubular reactor, where the central feed opening of the tubular reactor was located at 40% of the total tube length of the tubular reactor. The mass fraction of ethylene-vinyl acetate copolymer in the materials exiting the tubular reactor was 26%. The tubular reactor had an inlet pressure of 225 MPa and an outlet pressure of 185 MPa. An average flow rate of the materials in the tubular reactor was 14 m/s, and the operating temperature was 215° C.

The absolute value of a difference between an inlet pressure of the tank reactor and an inlet pressure of the tubular reactor was 10 MPa; a difference between an outlet pressure of the tank reactor 6 and an outlet pressure of the tubular reactor was 35 MPa.

The reaction was initiated in the tank reactor 6 by using an organic peroxide. The organic peroxide species were bis(2-ethylhexyl) peroxydicarbonate and tert-butyl peroxyvalerate with a mass ratio of 1:1.

The reaction was initiated in a tubular reactor by using an organic peroxide. The organic peroxide species were bis(2-ethylhexyl) peroxydicarbonate, tert-butyl peroxyvalerate, tert-butyl peroxy-2-ethylhexanoate, and tert-butyl peroxybenzoate with a mass ratio of 1:1:1:1. The organic peroxides entered the tubular reactor at 0 m, 600 m, 1,080 m of the total tube length of the tubular reactor, respectively.

The content of vinyl acetate in the ethylene-vinyl acetate copolymer was 27 wt %. The conversion rate of ethylene monomer was 26%. The pressure drop of the tubular reactor was 40 MPa.

The ethylene monomer conversion rate of Example 1 was increased by 18% than the Comparative Example 1; the ethylene monomer conversion rate of Example 2 was increased by 53% than the Comparative Example 2, and the ethylene monomer conversion rate of Example 2 was increased by 30% than the Comparative Example 3.

### Example 3

An ethylene-polar monomer copolymer was prepared in the high pressure free radical polymerization device shown in the FIGURE, the preparation conditions different from Example 2 were as follows:

The materials exiting the tank reactor 6 was cooled to 190° C., and then entered a tubular reactor at a location (the central feed opening) with a distance of 600 m from an inlet of the tubular reactor, where the central feed opening of the tubular reactor was located at 66.7% of the total tube length of the tubular reactor. The mass fraction of ethylene-vinyl acetate copolymer in the materials exiting the tank reactor 6 was 15%.

The organic peroxides entered the tubular reactor at 0 m, 600 m of the total tube length of the tubular reactor, respectively.

The content of vinyl acetate in the ethylene-vinyl acetate copolymer was 27 wt %. The conversion rate of ethylene monomer was 20%. The pressure drop of the tubular reactor was 18 MPa.

Example 3 had a significantly reduced pressure drop than the Comparative Example 1; the ethylene monomer conversion rate of Example 3 was increased by 18% than the Comparative Example 2; Example 3 had a lower reactor pressure drop than the Comparative Example 3 under the same ethylene monomer conversion rate condition.

### Comparative Example 1

An ethylene-polar monomer copolymer was produced with a tubular process in a tubular reactor, where the polar monomer was vinyl acetate. Unlike Example 1, the tubular reactor of Comparative Example 1 was further extended by 400 m over the total tube length of Example 1 and added an injection point of the organic peroxide, such that the conversion rate of ethylene monomer exiting the tubular reactor was further improved. The organic peroxide entered the tubular reactor at 0 m, 540 m, 1,020 m, and 1,450 m of the total tube length of the tubular reactor, respectively. The content of vinyl acetate in the ethylene-vinyl acetate copolymer was 27 wt %. The conversion rate of ethylene monomer was 22%. The pressure drop of the tubular reactor was 45 MPa.

The ethylene monomer conversion rate in Comparative Example 1 was increased to 22%. Although the extended tube length of tubular reactor in Comparative Example 1 was conducive to increasing the ethylene monomer conversion rate, the ethylene monomer conversion rate was still significantly lower than the ethylene monomer conversion rate of Example 1; and the pressure drop of the tubular reactor was significantly increased.

### Comparative Example 2

An ethylene-polar monomer copolymer was prepared in a tank reactor of Example 1 with a kettle process, the polar monomer was vinyl acetate. Unlike Example 1, for the sake of increasing the monomer conversion rate, the feed temperature of the tank reactor was 30° C., the operating pressure of the tank reactor was 220 MPa, the operating temperature was 210° C., and the flow rate was 90 tons per hour. The content of vinyl acetate in the ethylene-vinyl acetate copolymer was 27 wt %. The conversion rate of ethylene monomer was 17%.

### Comparative Example 3

An ethylene-polar monomer copolymer was prepared with a combination of the tank reactor and the tubular reactor, the polar monomer was vinyl acetate. Unlike Example 1, Comparative Example 3 initially produced a first fraction of ethylene-polar monomer copolymer in a tank reactor, and then directly introduced the materials exiting the tank reactor into an inlet (main feed inlet) of the tubular reactor in Example 1, the ethylene-polar monomer copolymer product was obtained. The polar monomer was vinyl acetate. Because the tubular reactor was located downstream the tank reactor, the operating pressure of the tubular reactor was 240 MPa. To avoid the large pressure drop, the total tube length of the tubular reactor of Comparative Example 3 was shortened by 430 m compared to Example 1, and reduced an injection point of the organic peroxide. The organic peroxide entered the tubular reactor at 0 m and 540 m of the total tube length of the tubular reactor, respectively. The content of vinyl acetate in the ethylene-vinyl acetate copolymer was 27 wt %. The conversion rate of ethylene monomer was 20%. The pressure drop of the tubular reactor was 22 MPa.

The above examples merely represent several embodiments of the present disclosure, and the examples are described in the relatively specific and detailed, but the examples cannot be construed as limitations to the protection scopes of the invention patent. Several variations and modifications can be made by those skilled in the art without departing from the inventive concept of the present disclosure, each of the variations and modifications falls into the protection scopes of the present disclosure.

1. A method for preparing an ethylene-polar monomer copolymer comprising: providing at least one tank reactor and a tubular reaction system comprising at least one tubular reactor; contacting ethylene, a polar monomer, and an organic peroxide and carrying out a polymerization reaction in the tank reactor and the tubular reactor under conditions including a pressure of 100-400 MPa and a temperature of 120-350° C. to prepare the ethylene-polar monomer copolymer;
wherein materials exiting the tank reactor are either cooled or not cooled and introduced into a central feed opening of the one or more tubular reactors, or a position at 10%-80% of the total tube length of a plurality of tubular reactors connected in series, the central feed opening of the tubular reactor is located at 10%-80% of the tube length of the tubular reactor.

2. The method of claim 1, wherein the polar monomer is vinyl acetate, an acrylic ester monomer having 4-12 carbon atoms, or a methacrylate monomer having 4-12 carbon atoms.

3. The method of claim 1, wherein the tank reactor has an operating pressure of 120-350 MPa; an operating temperature of 135-280° C.

4. The method of claim 3, wherein the tank reactor has an operating pressure of 150-270 MPa; an operating temperature of 145-250° C.

5. The method of claim 1, wherein the tubular reactor has an operating pressure of 120-350 MPa; an operating temperature of 135-280° C.

6. The method of claim 5, wherein the tubular reactor has an operating pressure of 150-270 MPa; an operating temperature of 145-250° C.

7. The method of claim 1, wherein an absolute value of a difference between an inlet pressure of the tank reactor and an inlet pressure of the tubular reaction system is less than or equal to 40 MPa, and a difference between an outlet pressure of the tank reactor and an outlet pressure of the tubular reaction system is more than or equal to 5 MPa.

8. The method of claim 1, wherein an average flow rate of the materials in the tubular reactor is within a range of 10-25 m/s.

9. The method of claim 8, wherein an average flow rate of the materials in the tubular reactor is within a range of 12-20 m/s.

10. The method of claim 1, wherein a concentration of the ethylene-polar monomer copolymer in the materials at the tubular reaction system outlet is higher than a concentration of the ethylene-polar monomer copolymer at the tank reactor outlet.

11. The method of claim 10, wherein the concentration of the ethylene-polar monomer copolymer in the materials at the tubular reaction system outlet is more than 1.2 times the concentration of the ethylene-polar monomer copolymer at the tank reactor outlet.

12. The method of claim 1, wherein a mass fraction of polar monomer in the obtained ethylene-polar monomer copolymer prepared by the method is within a range of 3-45 wt %.

13. The method of claim 12, wherein a mass fraction of polar monomer in the obtained ethylene-polar monomer copolymer prepared by the method is within a range of 10-35 wt %.

14. The method of claim 1, wherein a molecular weight regulator is further added into the tank reactor and/or the tubular reaction system during the polymerization reaction, the molecular weight regulator is selected from hydrogen gas, C₁-C₆ alkanes, C₁-C₆ alkenes, aldehydes, ketones or alcohol compounds.

15. The method of claim 14, the molecular weight regulator is selected from propylene, butene, hexene, propyl aldehyde, butyl aldehyde, or acetone.

16. The method of claim 1, wherein the central feed opening of the tubular reactor is located at 25%-60% of the tube length of the tubular reactor.

17. A device for preparing an ethylene-polar monomer copolymer comprising: a tubular reaction system comprising at least one tubular reactor, and at least one tank reactor;
at least one heat exchanger connected with an inlet of the tank reactor;
at least one heat exchanger connected with an inlet of the tubular reactor;
at least one pressure reducing valve located upstream or downstream of the tank reactor; and
at least one pressure reducing valve connected to an outlet of the tubular reactor;
wherein materials exiting the tank reactor are either cooled or not cooled and introduced into a central feed opening of the one or more tubular reactors, or a position at 10%-80% of the total tube length of a plurality of tubular reactors connected in series, the central feed opening of the tubular reactor is located at 10%-80% of the tube length of the tubular reactor.
